(19) United States
(12) Patent Application Publication
(10) Pub. No.: US 2025/0296309 A1
(43) Pub. Date: Sep. 25, 2025

(54) WATER RESISTANT FIBER CORRUGATED OUTDOOR SIGN

(71) Applicant: WestRock Shared Services, LLC, Atlanta, GA (US)

(72) Inventors: Daniel ROSS, Atlanta, GA (US); John HAMSNESS, Atlanta, GA (US); Jonathan SYERS, Atlanta, GA (US)

(21) Appl. No.: 19/086,997

(22) Filed: Mar. 21, 2025

Related U.S. Application Data
(60) Provisional application No. 63/568,281, filed on Mar. 21, 2024.

(51) Int. Cl. B32B 29/00; B32B 7/06; B32B 7/12; B32B 29/06; B32B 29/08; B32B 38/00

(52) U.S. Cl. CPC B32B 29/002; B32B 7/06; B32B 7/12; B32B 29/06; B32B 29/08; B32B 38/145; B32B 2250/03; B32B 2250/26; B32B 2250/40; B32B 2255/12; B32B 2255/26; B32B 2255/28; B32B 2307/7163; B32B 2307/73; B32B 2317/12; B32B 2317/127; B32B 2590/00

(57) ABSTRACT

A recyclable composite sign that includes a first coating layer, a second coating layer, a first paperboard layer coupled to the first coating layer and located between the first coating layer and the second coating layer, a second paperboard layer coupled to the second coating layer and located between the first paperboard layer and the second coating layer, and a corrugated layer located between, and coupled to, the first paperboard layer and the second paperboard layer.

### TECHNICAL FIELD

This disclosure relates generally to signs, and more particularly, to composite paper-based materials for signs.

### BACKGROUND

Conventional disposable signs may often be staked in yards or used in businesses. For example, disposable signs may frequently be used to visually display information, such as information pertaining to a retail store, a political organization, other commercial and/or consumer groups, or a combination thereof. Such signs may be disposable so that, after use, the signs may be disposed of easily with conventional garbage. The disposable signs may frequently be made from corrugated plastic materials to withstand outdoor conditions, such as temperature fluctuation, debris, moisture, or a combination thereof. Similarly, the corrugate plastic materials often used may provide a durable and structurally rigid material that may maintain its shape and upright orientation to display information.

### SUMMARY

In one aspect of the present disclosure, a recyclable composite sign is disclosed. The recyclable composite sign includes a first coating layer, a second coating layer, a first paperboard layer coupled to the first coating layer and located between the first coating layer and the second coating layer, a second paperboard layer coupled to the second coating layer and located between the first paperboard layer and the second coating layer, and a corrugated layer located between, and coupled to, the first paperboard layer and the second paperboard layer.

In some configurations, the first paper layer, the second paperboard layer, and the corrugated later may be non-wicking. The first paperboard layer, the second paperboard layer, and the corrugated layer may be free of a wax coating. The first coating layer and the second coating layer may form outer surfaces of the recyclable composite sign.

In some configurations, the recyclable composite sign may further include a first primer layer may be coupled to the first coating layer and a second primer layer coupled to the second coating layer. The first coating layer and the second coating layer may be located between the first primer layer and the second primer layer. The first primer layer and the second primer layer may be a coating material applied to the first coating layer and the second coating layer, respectively. Information may be printed directly on the first primer layer and the second primer layer, and the first primer layer and the second primer layer are moisture resistant.

In some configurations, information may be printed directly on the first coating layer and the second coating layer. The first coating layer and the second coating layer may be moisture resistant. The corrugated layer may define one or more channels that are configured to receive a support to mount the recyclable composite sign. One or more terminal edges of the recyclable composite sign may define an open end of the one or more channels such that the one or more channels may be accessible through the open end.

In some configurations, the first paperboard layer and the second paperboard layer may be a cupstock paper material.

In some configurations, the first paperboard layer and the second paperboard layer may be coupled to the corrugated layer by a starch that bonds the first paperboard layer and the second paperboard layer to the corrugated layer.

In some configurations, the corrugated layer may be biodegradable. The corrugated layer may be a corrugated paper material.

In another aspect of the present disclosure, a sign assembly is disclosed. The sign assembly includes a recyclable composite sign and a support coupled to the recyclable composite that is configured to secure the recyclable composite sign in a desired location. The recyclable composite sign includes a first coating layer, a second coating layer, a first paperboard layer coupled to the first coating layer and located between the first coating layer and the second coating layer, a second paperboard layer coupled to the second coating layer and located between the first paperboard layer and the second coating layer, and a corrugated layer located between, and coupled to, the first paperboard layer and the second paperboard layer.

In some configurations, the corrugated layer may define one or more channels that are configured to receive and secure the support.

In some configurations, the recyclable composite sign may further include a first primer layer coupled to the first coating layer and a second primer layer coupled to the second coating layer.

In some configurations, the first paperboard layer, the second paperboard layer, and the corrugated layer may be free of a wax coating.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a front view of a sign assembly including a sign in accordance with the present teachings.

FIG. 2A is cross-section 2A of the sign of FIG. 1.

FIG. 2B is another example of a cross-section of the sign of FIG. 1.

FIG. 2C is another example of a cross-section of the sign of FIG. 1.

FIG. 2D is another example of a cross-section of the sign of FIG. 1.

### DETAILED DESCRIPTION

The present teachings generally relate to composite signs. In particular, the present teachings generally relate to composite, paper-based materials that may be used as an alternative material to conventional disposable sign materials. The signs described herein may be used in a similar manner to conventional disposable signs. For example, the signs described herein may be secured in any desired fashion indoors and/or outdoors to display various textual and/or graphical information.

Conventional sign materials, such as corrugated plastics, may be frequent used due to their durability and moisture-resistance, especially in outdoor applications. The corrugated plastic signs may maintain their shape and prevent degradation that may typically occur due to outdoor weather conditions, such as wind, rain, snow, sun exposure, the like, or a combination thereof. However, while corrugated plastic signs may exhibit structural integrity, the materials used are often non-recyclable and require disposal in a landfill. As a result, the environmental impact from manufacturing and using such corrugated plastic signs, especially when used in a manner that requires frequent disposal and/or replacement, may be significant compared to other materials utilized in similar industries. Additionally, such corrugated plastic signs may pose a challenge for printability of text and/or graphics directly on a surface of the sign. Therefore, additional steps may be needed to ensure text and/or graphics may be properly displayed, such as using an additional substrate (e.g., a laminate material, tape, adhesive), specific types of materials may be required to ensure text and/or graphics may be properly displayed, or both.

Advantageously, the composite signs described herein may provide solutions to the aforementioned problems. That is, the composite signs described herein may provide an alternative material to conventional corrugated plastic materials used for disposable signs. The composite signs described herein may be environmentally friendly. For example, the composite signs may be made from various paper-based materials that may be recyclable, compostable, or both. Moreover, the composite signs may be moisture-resistant, economical (e.g., cheaper than conventional corrugated plastic materials), lightweight, non-wicking, durable, ultraviolet (UV) resistant, or a combination thereof.

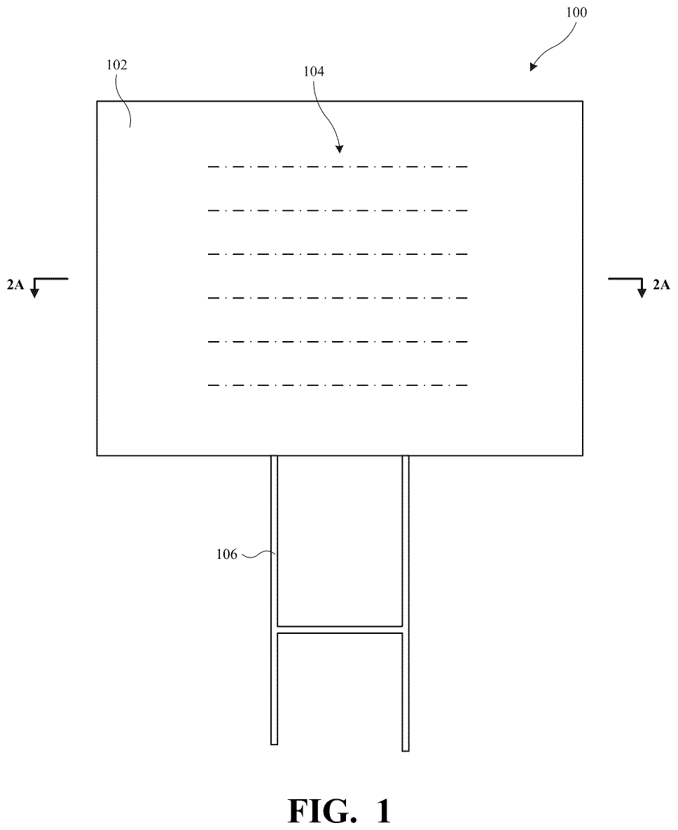

Turning now to the figures, FIG. 1 illustrates a front view of a sign assembly 100 in accordance with the present teachings. The sign assembly 100 may include a sign 102 that may be configured to display information 104 for various targeted demographics. For example, the information 104 may be text and/or graphics to promote various organizations, businesses, events, locations, people, political groups, or a combination thereof. As such, the information 104 is not limited to any particular type of information and may vary in size, shape, design, color, material, or a combination thereof. Similarly, the information 104 may be one or more objects that may be secured (e.g., adhered or mechanically coupled) to the sign 102 for display.

The sign 102 may be any size and/or shape to display the information 104. For example, the sign 102 may include two sides (i.e., a front side and a back side), whereby the information 104 may be displayed one or both of the two sides of the sign 102. The sign 102 may also include one or more edges that define a perimeter of the ides of the sign 102. Such edges may be exposed edges in which one or more internal layers of the sign 102 may be exposed. Alternatively, or additionally, such edges may be finished edges in which the internal layers of the sign 102 may be protected.

The sign 102 may be displayed in any desired manner. For example, the sign 102 may include, or may be configured, to mount to various structures (e.g., buildings, walls, windows, roofs, cars, trees, poles, fences, etc.) using one or more adhesives, one or more mechanical fasteners (e.g., nails, rivets, screws, staples, etc.), or both. By way of example, the sign assembly 100 may include a support 106 coupled to the sign 102. The support 106 may be a wire (e.g., metal) structure that may be configured for insertion into the ground, such as in a yard or flower bed. As such, the support 106 may facilitate display of the sign 102 in a manner that does not require the sign 102 to be directly coupled to a structure. That is, the sign 102 may be staked in the ground and be free of contact with the ground. Thus, based on the above, it should be noted that the sign 102 may be displayed in any desired location, whether outdoors or indoors.

The sign 102 (e.g., one or more materials of the sign 102) may exhibit various material properties such that the sign 102 may be located indoors or outdoors and withstand various environmental conditions. For example, the sign 102 may be configured for display outdoors (e.g., using the support 106), whereby the sign 102 may be moisture-resistant, debris-resistant, non-wicking, ultraviolet (UV) resistant, puncture resistant, antimicrobial, antifungal, the like, or a combination thereof. Similarly, the sign 102 may exhibit material properties that may withstand significant temperature fluctuations and/or temperature cycling, in which case the sign 102 may maintain its structural integrity. For example, the sign 102 as described herein may exhibit substantially similar material properties to a conventional corrugated plastic sign yet provide a more economically and environmentally friendly solution.

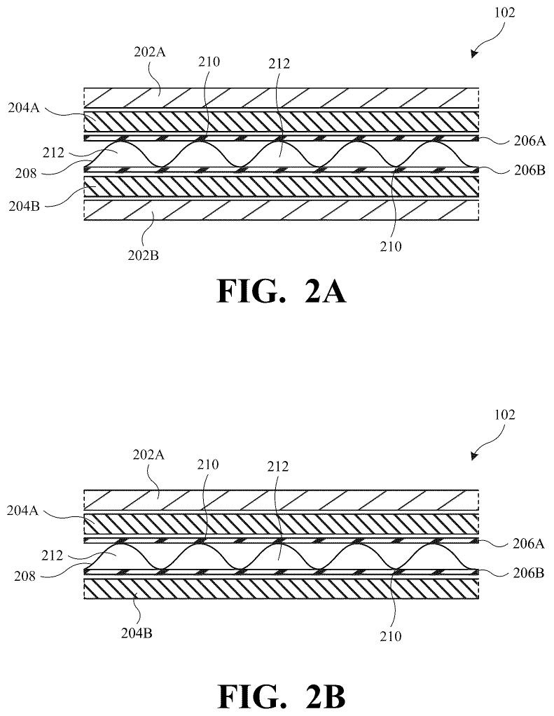

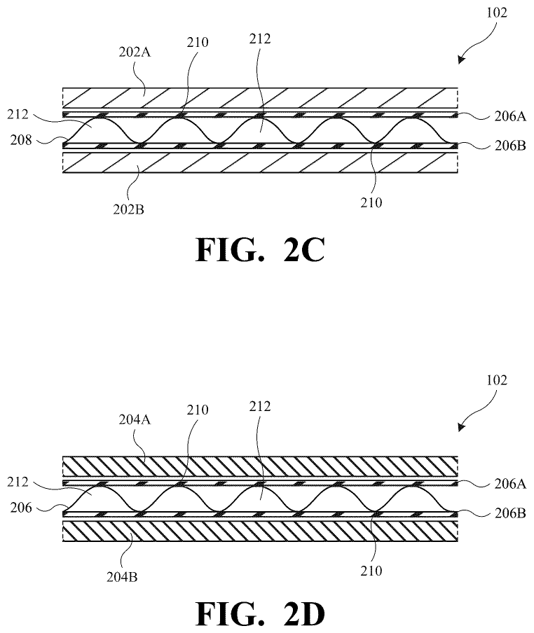

FIG. 2A illustrates cross-section 2A of the sign 102 shown in FIG. 1. As discussed above, the sign 102 may be made from a composite material that contains one or more layers. The number of layers may vary based on a desired application of the sign 102, and thus the cross-section of the sign 102 shown in FIG. 2A is only intended as an example of a structure of the sign 102 and is not intended to limit the teachings herein. Additionally, it should be noted that the layers of the sign 102 described below are illustrated in a spaced apart relationship for further clarity. That is, one or more of the layers of the sign 102 may be directly coupled to one another or one or more materials may be located between the one or more layers of the sign 102 to secure the one or more layers to one another and form the overall composite material. For example, the one or more layers may include an adhesive therebetween to secure the one or more layers to each other.

The sign 102 may include one or more primer layers, one or more coating layers, one or more paperboard layers, one or more corrugated layers, or a combination thereof. All of the layers of the sign 102 described herein may be recyclable, compostable, or both. By way of example, the sign 102 may include a first primer layer 202A, a second primer layer 202B, a first coating layer 204A, a second coating layer 204B, a first paperboard layer 206A, a second paperboard layer 206B, and a corrugated layer 208. While positioning of the layers shown in FIG. 2A are described in detail below, the aforementioned layers may be positioned in any desired manner relative to each other. However, such positioned as described below may provide beneficial material properties to such that the sign 102 may exhibit the various material properties described above.

The first primer layer 202A and the second primer layer 202B may form outer layers of the sign 102. The first primer layer 202A and the second primer layer 202B may be positioned on opposing sides of the sign 102 as outermost layers such that the first primer layer 202A and the second primer layer 202B may form a front side and a back side, respectively, of the sign 102. The first primer layer 202A and the second primer layer 202B be any thickness. Similarly, the first primer layer 202A and/or the second primer layer 202B may be coextensive with the first coating layer 204A, the second coating layer 204B, the first paperboard layer 206A, the second paperboard layer 206B, the corrugated layer 208, or a combination thereof.

The first primer layer 202A and the second primer layer 202B may be the same material or different materials. The first primer layer 202A and the second primer layer 202B may be a coating applied to other layers of the sign 102, such as the first coating layer 204A and the second coating layer 204B. The first primer layer 202A and the second primer layer 202B may be a water-based material that may be configured for grease and/or oil resistance. Similarly, the first primer layer 202A and the second primer layer 202B may be or may include a material that exhibits water-resistance, coldset gluability, hot melt gluability, or a combination thereof. Additionally, the first primer layer 202A and the second primer layer 202B may be a material that may be in compliance with various food contact regulations (e.g. U.S. Food and Drug Administration (FDA) regulations).

The first primer layer 202A and the second primer layer 202B may be printable (e.g., may facilitate printing directly on the first primer layer 202A and the second primer layer 202B and may exhibit improved ink absorption for printing). Additionally, the first primer layer 202A and the second primer layer 202B may exhibit anti-scuffing properties during manufacturing (e.g., corrugation) such that the information 104 displayed on the sign 102 along one or more exterior surfaces (e.g., on the first primer layer 202A and/or the second primer layer 202B) may maintain its visual appearance. Furthermore, the first primer layer 202A and the second primer layer 202B may also minimize blocking during manufacturing and exhibit a stable surface energy. By way of example, the first primer layer 202A and the second primer layer 202B may be Michelman® Michem® Coat 415A.

The first primer layer 202A may be coupled to the first coating layer 204A and the second primer layer 202B may be coupled to the second coating layer 204B. Such coupling may be done using various adhesives or other materials. Such coupling may be done so that the first primer layer 202A and the second primer layer 202B are directly coupled to the first coating layer 204A and the second coating layer 204B, respectively.

The first coating layer 204A and the second coating layer 204B may be a similar or different materials to one another, compared to the first primer layer 202A and the second primer layer 202B, or a combination thereof. For example, a material of the first coating layer 204A and the second coating layer 204B may be complimentary and/or compatible with the material of the first primer layer 202A and the second primer layer 202B such that bonding of the first primer layer 202A and the second primer layer 202B to the first coating layer 204A and the second coating layer 204B, respectively, may be done successfully.

By way of example, the first coating layer 204A and the second coating layer 204B may be or may form an additional coating of the sign 102. That is, the first primer layer 202A and the second primer layer 202B may be considered a first coating of the sign 102 and the first coating layer 204A and the second coating layer 204B may be considered a second coating of the sign 102. The first coating layer 204A and the second coating layer 204B may have any desired thickness.

The first coating layer 204A and the second coating layer 204B may be a water-based coating mater that may be grease and/or oil resistant, moisture-resistant, or both. The first coating layer 204A and the second coating layer 204B may exhibit coldset gluability, hot melt gluability, or both. The first coating layer 204A and the second coating layer 204B may be a material that may be in compliance with various food contact regulations (e.g., U.S. FDA regulations). The first coating layer 204A and the second coating layer 204B may be repulpable, printable, or both. The first coating layer 204A and the second coating layer 204B may provide a water and/or moisture vapor barrier for more interior layers (e.g., the first paperboard layer 206A, the second paperboard layer 206B, the corrugated layer 208, or a combination thereof) of the sign 102. The first coating layer 204A and the second coating layer 204B may provide a base coating to apply the first primer layer 202A and the second primer layer 202B. By way of example, the first coating layer 204A and the second coating layer 204B may be Michelman® Michem® Coat 81.

The first coating layer 204A may be coupled to the first paperboard layer 206A and the second coating layer 204B may be coupled to the second paperboard layer 206B. Such coupling may be done using various adhesives or other materials. Such coupling may be done so that the first coating layer 204A and the second coating layer 204B are directly coupled to the first paperboard layer 206A and the second paperboard layer 206B, respectively.

The first paperboard layer 206A and the second paperboard layer 206B may be similar or different materials to one another. The first paperboard layer 206A and the second paperboard layer 206B may be a coated or uncoated. For example, the first paperboard layer 206A and the second paperboard layer 206B may be coated by the first coating layer 204A and the second coating layer 204B, respectively. The first paperboard layer 206A and the second paperboard layer 206B may be a paper liner material, such as the outer layers of the corrugated board described in U.S. Application Publication No. 2022/0396061, the entirety of which is incorporated by reference herein for all purposes.

The first paperboard layer 206A and the second paperboard layer 206B may be Biodegradable Products Institute (BPIR) certified for industrial composting. The first paperboard layer 206A and the second paperboard layer 206B may be compostable per the guidelines outlined in ASTM D6868). The first paperboard layer 206A and the second paperboard layer 206B may withstand liquid holdout challenges associated with various liquids, thereby promoting further water resistance of the sign 102. The first paperboard layer 206A and the second paperboard layer 206B may form at least a portion of the structure shape of the sign 102 in conjunction with the corrugated layer 208. That is, the first paperboard layer 206A and the second paperboard layer 206B may be formable and tuned to provide a desired thickness, stiffness, color, weight, or a combination thereof. The first paperboard layer 206A and the second paperboard layer 206B may also be compliant with various food contact regulations (e.g. U.S. Food and Drug Administration (FDA) regulations). By way of example, the first paperboard layer 206A and the second paperboard layer 206B may be WestRock TruServ® Uncoated Cupstock.

The first paperboard layer 206A and the second paperboard layer 206B may be positioned on opposing sides of the corrugated layer 208. The corrugated layer 208 may be shaped (e.g., corrugated) to include a plurality of channels 212 therein. The channels 212 may include one or more open ends such that an item, such as the support 106) may be inserted into one or more of the channels 212 to secure the sign 102. Additionally, the corrugated layer 208 may be shaped (e.g., corrugated) to include one or more peaks 210, whereby the peaks 210 may be directly or indirectly coupled to the first paperboard layer 206A and/or the second paperboard layer 206B, such as by an adhesive, a starch that bonds the first paperboard layer 206A and the second paperboard layer 206B to the corrugated layer 208, other bonding agent, or a combination thereof.

Based on the above, the first paperboard layer 206A, the second paperboard layer 206B, the corrugated layer 208, or a combination thereof may be non-wicking such that a 24-hour edgewick-test wick distance from an edge is less than about 6 mm. Edgewick testing may be completed using samples of the sign 102 cut into strips and partially inserted into 600 mL of room temperature water for 24 hours.

The corrugated layer 208 may be formed (e.g., corrugated) with any desired thickness (e.g., a height of the peaks 210) and any number of the peaks 210. Similarly, while the corrugated layer 208 is shown in FIG. 2A, more than one of the corrugated layer 208 may also be used in the sign 102 to provide additional structural integrity and/or thickness.

The corrugated layer 208 may be a corrugated board material. The corrugated layer 208 may be moisture resistant and free of any wax coatings that may render the corrugated layer 208 unrecyclable. That is, the corrugated layer 208 may be recyclable and/or biodegradable. By way of example, the corrugated layer 208 may the non-wicking medium of the corrugated board described in U.S. Application Publication No. 2022/0396061, the entirety of which is incorporated by reference herein for all purposes.

While the above configuration shown in FIG. 2A may form the sign 102, various other configurations may also be possible. For example, FIGS. 2B-2D illustrate other examples of configurations of the composite material that may form the sign 102.

As shown in FIG. 2B, the sign 102 may include the first primer layer 202A, the first coating layer 204A, the second coating layer 204B, the first paperboard layer 206A, the second paperboard layer 206B, and the corrugated layer 208. Such layers may be the same or similar to those described above with respect to FIG. 2A. However, as shown in FIG. 2B, the sign 102 may not include the second primer layer 202B such that the second coating layer 204B may be exposed and form an outer layer of the sign 102 that opposes a side of the sign 102 formed by the first primer layer 202A.

As shown in FIG. 2C, the sign 102 may include the first primer layer 202A, the second primer layer 202B, the first paperboard layer 206A, the second paperboard layer 206B, and the corrugated layer 208. The sign 102 may not include the first coating layer 204A and the second coating layer 204B such that the first primer layer 202A and the second primer layer 202B may directly couple to the first paperboard layer 206A and the second paperboard layer 206B, respectively, thereby eliminating a second coating formed by the first coating layer 204A and the second coating layer 204B.

As shown in FIG. 2D, the sign 102 may include the first coating layer 204A, the second coating layer 204B, the first paperboard layer 206A, the second paperboard layer 206B, and the corrugated layer 208. The sign 102 may not include the first primer layer 202A and the second primer layer 202B such that the first coating layer 204A and the second coating layer 204B form opposing outer sides (e.g., the front side and the back side) of the sign 102. In such a case, the information 104 may be printed directly onto the first coating layer 204A and/or the second coating layer 204B.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°+25% (e.g., an angle that lies within the range of (approximately) 135° to (approximately)) 225°. The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A recyclable composite sign, comprising:
a first coating layer;
a second coating layer;
a first paperboard layer coupled to the first coating layer and located between the first coating layer and the second coating layer;
a second paperboard layer coupled to the second coating layer and located between the first paperboard layer and the second coating layer; and
a corrugated layer located between, and coupled to, the first paperboard layer and the second paperboard layer.

2. The recyclable composite sign of claim 1, wherein the first paperboard layer, the second paperboard layer, and the corrugated layer are non-wicking.

3. The recyclable composite sign of claim 1, wherein the first paperboard layer, the second paperboard layer, and the corrugated layer are free of a wax coating.

4. The recyclable composite sign of claim 1, wherein the first coating layer and the second coating layer form outer surfaces of the recyclable composite sign.

5. The recyclable composite sign of claim 1, further comprising:
a first primer layer coupled to the first coating layer; and
a second primer layer coupled to the second coating layer.

6. The recyclable composite sign of claim 5, wherein the first coating layer and the second coating layer are located between the first primer layer and the second primer layer.

7. The recyclable composite sign of claim 5, wherein the first primer layer and the second primer layer are a coating material applied to the first coating layer and the second coating layer, respectively.

8. The recyclable composite sign of claim 7, wherein information is printed directly on the first primer layer and the second primer layer, and the first primer layer and the second primer layer are moisture resistant.

9. The recyclable composite sign of claim 1, wherein information is printed directly on the first coating layer and the second coating layer.

10. The recyclable composite sign of claim 1, wherein the first coating layer and the second coating layer are moisture resistant.

11. The recyclable composite sign of claim 1, wherein the corrugated layer defines one or more channels that are configured to receive a support to mount the recyclable composite sign.

12. The recyclable composite sign of claim 11, wherein one or more terminal edges of the recyclable composite sign define an open end of the one or more channels such that the one or more channels are accessible through the open end.

13. The recyclable composite sign of claim 1, wherein the first paperboard layer and the second paperboard layer are a cupstock paper material.

14. The recyclable composite sign of claim 1, wherein the first paperboard layer and the second paperboard layer are coupled to the corrugated layer by a starch that bonds the first paperboard layer and the second paperboard layer to the corrugated layer.

15. The recyclable composite sign of claim 1, wherein the corrugated layer is biodegradable.

16. The recyclable composite sign of claim 1, wherein the corrugated layer is a corrugated paper material.

17. A sign assembly, comprising:
a recyclable composite sign that includes:
a first coating layer,
a second coating layer,
a first paperboard layer coupled to the first coating layer and located between the first coating layer and the second coating layer,
a second paperboard layer coupled to the second coating layer and located between the first paperboard layer and the second coating layer, and
a corrugated layer located between, and coupled to, the first paperboard layer and the second paperboard layer; and
a support coupled to the recyclable composite sign that is configured to secure the recyclable composite sign in a desired location.

18. The sign assembly of claim 17, wherein the corrugated layer defines one or more channels that are configured to receive and secure the support.

19. The sign assembly of claim 17, wherein the recyclable composite sign further comprising:
a first primer layer coupled to the first coating layer; and
a second primer layer coupled to the second coating layer.

20. The sign assembly of claim 17, wherein the first paperboard layer, the second paperboard layer, and the corrugated layer are free of a wax coating.
